(19) United States
(12) Patent Application Publication
(10) Pub. No.: US 2020/0031048 A1
(43) Pub. Date: Jan. 30, 2020

(54) MODULAR FILAMENT FEEDING AND TRACKING DEVICE FOR USE WITH AN ADDITIVE MANUFACTURING PRINTER

(71) Applicant: University of Central Florida Research Foundation, Inc., Orlando, FL (US)

(72) Inventors: Jack Stubbs, Orlando, FL (US); Michael Xynidis, Orlando, FL (US)

(21) Appl. No.: 16/521,806

(22) Filed: Jul. 25, 2019

Related U.S. Application Data
(60) Provisional application No. 62/703,281, filed on Jul. 25, 2018.

(51) Int. Cl. B29C 64/209; B29C 64/118

(52) U.S. Cl. CPC B29C 64/209; B33Y 10/00; B29C 64/118

(57) ABSTRACT

A stackable, modular additive manufacturing printer filament feed device including various modules, or components, used to track, quantify, feed, and treat filament used in a 3D printer. The device is designed to provide an accurate quantification of the amount of filament remaining in an additive manufacturing printer by tracking the bidirectional linear translation of filament being fed into the additive manufacturing printer. In addition, the device is portable and does not require an input from the printer to operate; instead, the device mechanically couples to the printer, such that filament passes through the device and is fed into the printer during a printing project. The stackable nature of the device allows for customization depending on printing needs—as such, the device can perform multiple functions, in addition to feeding and tracking filament to an additive manufacturing printer.

### CROSS-REFERENCE TO RELATED APPLICATIONS

This nonprovisional patent application is a continuation of and claims priority to provisional patent application No. 62/703,281, entitled “3D printer modular filament feeding, tracking, and treatment device,” filed on Jul. 25, 2018, by the same inventors, the entirety of which is incorporated herein by reference.

### BACKGROUND OF THE INVENTION

### 1. Field of the Invention

This invention relates, generally, to additive manufacturing printer filament feeding, tracking, and treatment devices. More specifically, it relates to a modular additive manufacturing printer filament feed device including a feeding mechanism and a tracking component, as well as other treatment components, thereby providing a singular system that translates, quantifies, tracks, and treats additive manufacturing printer filament during the additive manufacturing process.

### 2. Brief Description of the Prior Art

Consumer-grade additive manufacturing, or 3D, printers have been developed that provide high-quality and high-resolution prints for prototypes and simple models. Such consumer-grade additive manufacturing printers are typically low in cost, thereby providing a benefit of allowing the consuming public to engage with additive manufacturing printers. However, a consequence of the low cost of these printers is that the printers often suffer from reliability problems, leading to poor-quality prints, wasted financing, and wasted time. Some of these additive manufacturing printing problems result from issues with the filament, or the thermoplastic feedstock that serves as the raw material for the print. In particular, printers can use all of the available filament without providing an adequate warning to the user, because it is difficult for the user to determine the quantity of remaining filament on a reel. Similarly, by switching between filaments of different colors and materials, users often lose track of the filament status, leading to a printer running out of filament during a print.

Existing consumer-grade additive manufacturing printers include various forms of filament presence (also known as filament-out and filament run-out) sensors that function to indicate the presence (or lack) of filament on a reel. Presence sensors typically include one or more mechanical lever sensors that contact the surface of the filament within a contained area of an additive manufacturing printer. The sensors indicate the presence of the filament within the contained area, and the lack of filament within the area, and are typically used as rudimentary indicators of filament quantity. However, these presence sensors lack the ability to linearly track filament usage by a printer. In addition, the sensors do not actively calculate the quantity of filament remaining on a reel in real-time.

Some higher-end additive manufacturing printers include memory-based storage of information regarding filament usage on individual reels of filament. Similar to the consumer-grade additive manufacturing printers, these higher-end printers fail to linearly measure filament movement within the printer. Instead, the sensors in the printers detect filament presence and store an estimate of the remaining filament. While the estimates may be calculated in real-time, the lack of linear tracking yields inaccurate data on filament quantity. Other systems estimate filament quantity based on printed model progression, rotations made by an extruder of the printer, and filament diameter. In addition, some existing methods of filament usage detection include the use of magnets and. Hall-effect sensors to detect the use of filament during printing; however, these magnetic applications fail to detect filament travel direction, and instead simply detect the use of filament.

Accordingly, what is needed is a device that indicates the presence of filament in an additive manufacturing printer by measuring the linear movement of filament during printing, thereby yielding an accurate quantification of filament levels. What is also needed is a combination device that feeds filament into the additive manufacturing printer for use in a printing project; tracks and quantifies the amount of filament used during the printing project; and treats and coats the filament during the project. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The long-standing but heretofore unfulfilled need fur a stackable, modular filament treatment device that feeds filament to an extruder and an additive manufacturing printer, while tracking and quantifying the amount of remaining filament, is now met by a new, useful, and nonobvious invention.

The novel modular device includes at least a first module and a second module, each module performing one or more functions in the device, The modular device is configured to mechanically couple to an additive manufacturing printer that includes an extruder, and to a reel of filament. The first module includes a motorized feeder that couples to the reel of filament, with the feeder being adapted to receive filament from the reel, and drive the filament through the device toward the extruder. The second module includes a counter and is mechanically coupled to the feeder, such that the second module receives the filament from the feeder. The counter includes a sensor that is adapted to bidirectionally detect the presence of the filament received from the feeder as the filament linearly translates through the second module toward the extruder. The counter provides an accurate quantification of the amount of filament passing through the second module.

An embodiment of the modular device includes a third module disposed between the feeder and the extruder, with the third module including a drying element. The drying element is adapted to receive filament from the feeder, dry the filament, and prepare the filament for printing as the filament linearly translates through the third module toward the extruder. A further embodiment of the modular device includes a fourth module disposed between the feeder and the extruder, with the fourth module including a coating element that is adapted to receive filament from the feeder and apply a coating on the filament as the filament linearly translates through the fourth module toward the extruder, The fourth module may include a reservoir containing the coating to be applied to the filament.

In an embodiment, the counter module, which may be referred to as a quantification and tracking module, includes a first end opposite a second end with the channel spanning from the first end to the second end. A rotary assembly is disposed between the first end and the second end, with the rotary assembly including a set of coplanar wheels separated by a gap, with each of the wheels being disposed on opposing sides of the channel. The gap is defined by a lateral distance between a circumferential edge of each wheel, with the gap being smaller than a height of the channel, such that each circumferential edge at least partially extends into the channel. The first and second wheels are each mechanically coupled to a bearing about a central axis of each wheel, thereby reducing a frictional force acting on each wheel during rotation about the central axis. Each wheel is capable of clockwise and counterclockwise rotation, such that the wheels are adapted to track the bidirectional linear translation of the filament.

A method of preparing and quantifying filament is also provided, including receiving, from a reel of filament, a portion of the filament at a first module. The first module includes a motorized feeder and drives the portion of filament toward an extruder of an additive manufacturing machine. The method includes a step of passing filament through a second module that includes a counter mechanically coupled to the feeder. The counter is adapted to bidirectionally detect the presence of filament as the filament linearly translates through the second module toward the extruder. The method includes drying the portion of filament at a third module including a drying element, and coating the portion of filament at a fourth module including a coating element. In an embodiment, the method includes passing the portion of filament through a channel of the second module; contacting the portion of filament with a circumferential edge of a first and second wheel of the second module; and rotating each wheel as the filament linearly translates through the second module. An amount of rotation of each of the first and second wheels quantifies an amount of filament remaining on the reel.

An object of the invention is to provide a stackable, modular filament treatment device, wherein the different components of the device synergistically function to translate, quantify, track, and treat filament used by an additive manufacturing printer during a printing project. As such, the device works in connection with an additive manufacturing printer to not only complete the printing project, but also provides a real-time calculation of the amount of filament left on a reel, decreasing the chance that the printer will run out of filament during a project.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a depiction of a stackable, modular filament feeding, tracking, and treating device that receives filament from a reel and drives the filament to an extruder, in accordance with and embodiment of the present invention.

FIG. 2 is a top plan view of a treatment module of the device of FIG. 1, including a coating mechanism designed to receive uncoated filament, coat the filament, and drive the coated filament to an additive manufacturing printer.

FIG. 3A is a side orthogonal view of a tracking and quantification module of a stackable, modular filament feeding, tracking, and treating device, showing coplanar wheels and a strand of filament disposed between the wheels.

FIG. 3B is a perspective view of the tracking and quantification module of FIG. 3A, showing bearings that aid in the rotation of the wheels of the module.

FIG. 3C is an orthogonal view of a stackable, modular filament feeding, tracking, and treating device, particularly showing the tracking and quantification module of FIG. 3A coupled to an electrical breadboard of the device.

FIG. 3D is a perspective view of the device of FIG. 3C, particularly showing the relationship between the tracking and quantification module and the stackable, modular filament feeding, tracking, and treating device.

FIG. 4 is a process flow diagram depicting a method of treating filament for use in combination with an additive manufacturing printer having an extruder.

### DETAILED DESCRIPTION OF THE INVENTION

In the following detailed description of the preferred embodiments, reference is made to the accompanying drawings, which form a part thereof, and within which are shown by way of illustration specific embodiments by which the invention may he practiced. It is to be understood that other embodiments may be utilized and structural changes may be made without departing from the scope of the invention.

As used in this specification and the appended claims, the singular forms “a,” “an”, and “the” include plural referents unless the content clearly dictates otherwise. As used in this specification and the appended claims, the term “or” is generally employed in its sense including “and/or” unless the context clearly dictates otherwise.

The present invention includes a modular device including various modules, or components, used to track, quantify, feed, and treat filament used in an additive manufacturing printer. The device is designed to be retrofit onto existing additive manufacturing printers, or included during the manufacturing of new additive manufacturing printers. The device is designed to provide an accurate quantification of the amount of filament remaining in an additive manufacturing printer by tracking the linear movement—both in the forward and backward directions—of filament being fed into the printer. In addition, the device is portable and does not require an input from the printer to operate; instead, the device is mechanically coupled to the printer, such that filament passes through the device and is fed into the printer during a printing project.

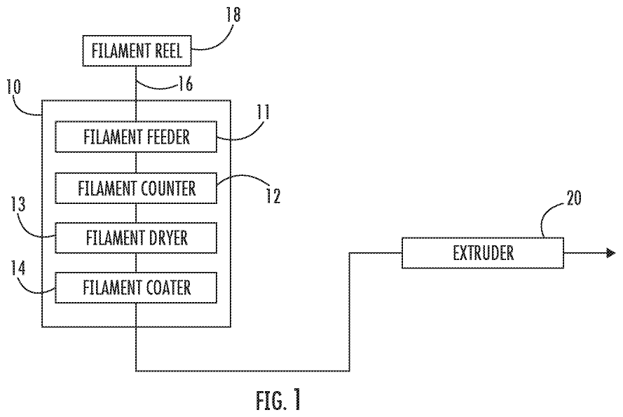

As shown in FIG. 1, a typical additive manufacturing printing system includes filament 16 on reel 18 (alternatively, a cartridge, roll, or spool), with filament 16. In an embodiment, a strand of filament 16 on reel 18 is 1.75 mm or 3 mm in diameter; however, it is appreciated that filament 16 of varying diameters can be used in combination with the system described herein, so long as filament 16 can be received the system. In a typical additive manufacturing system, a feeding mechanism drives filament 16 from reel 18 to extruder 20, which heats the filament for use during printing. Extruder 20 then feeds and pushes the heated filament 16 through a nozzle, through which filament 16 is extruded and used in additive manufacturing projects once filament 16 is properly prepared for printing. As shown in FIG. 1, device 10 is adapted to be an intermediary device between the typical prior art reel 18 and extruder 20. As an intermediary component in the system, device 10 receives filament 16 from reel 18, and feeds filament 16 to extruder 20 for use in an additive manufacturing project. As shown in FIG. 1, in an embodiment of the instant invention, device 10 includes a plurality of modules, including feeder 11, counter 12, dryer 13, and coater 14; however, it is appreciated that device 10 may simply include feeder 11 and counter, or may include further modules in addition to those depicted in FIG. 1.

In the embodiment of FIG. 1, device 10 receives filament 16 at feeder 11, which includes a motor to pull filament 16 from reel 18, and push filament 16 through device 10 toward extruder 20 in mechanical communication with an additive manufacturing printer. The motor drive may consist of a stepper, servo, or other motor drive, so long as the motor drive is capable of linearly translating filament 16 within device 10 from reel 18 toward extruder 20. Next, filament 16 contacts counter 12 within device 10, which may be an optical or contact counter. For example, in an embodiment, counter 12 is a rotary wheel counter that is disposed within device 10 and includes an outer edge that at least partially intersects a linear translation path of filament 16 from reel 18 to extruder 20. In this embodiment, filament 16 contacts counter 12 as filament 16 translates through device 10 via feeder 11, and counter 12 rotates when contacted by filament 16. A processor or memory electrically coupled to counter 12 calculates an amount of counter 12 that rotates as filament 16 translate through device 10, such that device 10 tracks an amount of filament 16 remaining on reel 18. A rotary wheel counter provides a benefit of recognizing bidirectional movement of filament 16, allowing for a more accurate quantification of the amount of filament 16 on reel 18. An optical counter provides similar benefits. Regardless of the sensing method, counter 12 is used to quantify the amount of filament 16 passing through device 10, and thereby the amount of filament 16 being used by the additive manufacturing printer.

Device 10 also prepares filament 16 for printing through dryer 13. Dryer 13 can perform a variety of functions, such as wiping and drying filament 16 to remove moisture, dust, debris, and other foreign material that can interfere with a successful printing project. Dryer 13 can also include a dried air flow or a recirculation of air to dry filament 16, a desiccant-filled reservoir to remove moisture from filament 16, or an active or passive heating element to dry and prepare filament 16. Importantly, after passing through dyer 13, filament 16 is substantially dry and free of residual materials for accurate printing, decreasing the chance of filament 16 printing errors.

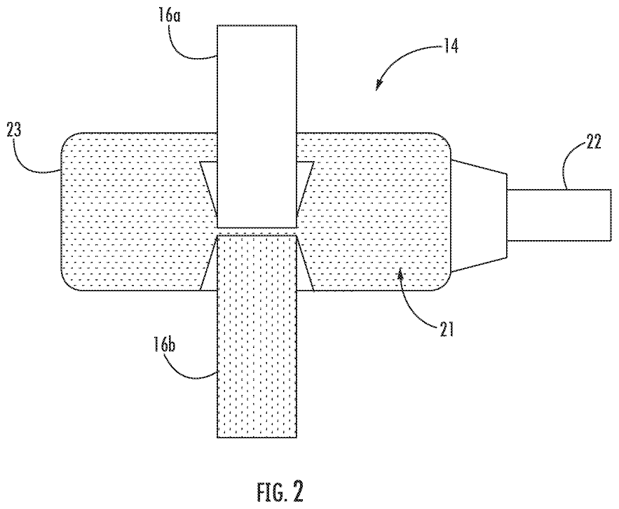

Before feeding filament 16 to extruder 20, device 10 passes filament 16 through coater 14. Coater 14 can include a variety of coating mechanisms for the purpose of applying a thin, controlled layer of a solution to the surface areas of filament 16. For example, coater 14 can coat at least a portion of the surface of filament 16 with an amount of paint, ink, conductive field, nanotube sensor fluid, or other similar coating materials, broadening the capabilities of the additive manufacturing printing project. Coater 14 is shown in greater detail in FIG. 2, depicting uncoated filament 16a entering coater 14, receiving coating 21 from coater 14, and becoming coated filament 16b, which exits coater 14. Coater 14 also includes injection port 22, through which coating 21 is inserted and stored within reservoir 23. In an embodiment, reservoir 23 includes a quantification component including a fluid level sensor disposed therein, designed to alert a user of a low level of coating 21. As such, the user can refill reservoir 23 through injection port 22. In another embodiment, coater 14 includes a spray-nozzle configuration for providing a controlled, uniform coating disposed on filament 16 as filament 16 passes through device 10. In yet another embodiment, coater 14 utilizes film evaporation, laser-assisted deposition, or other methods to provide coating 21 for filament 16, thereby preparing filament 16 for printing.

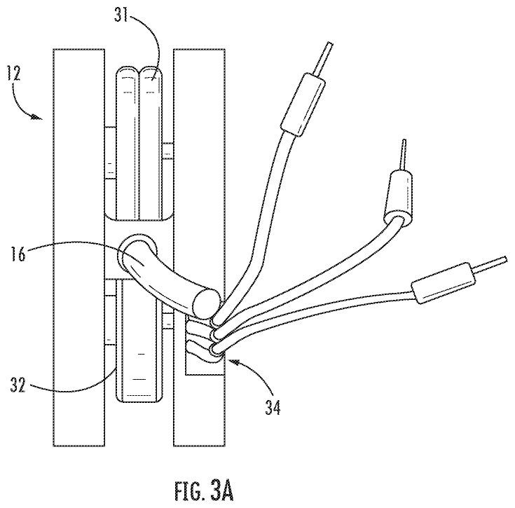

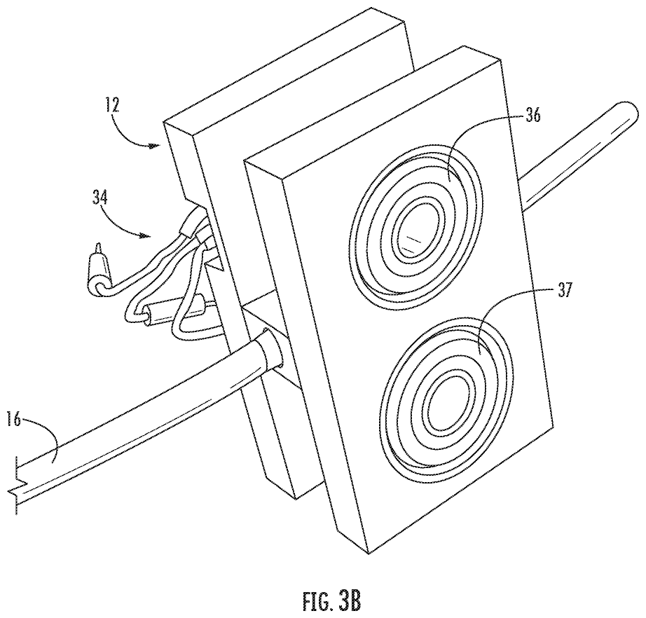

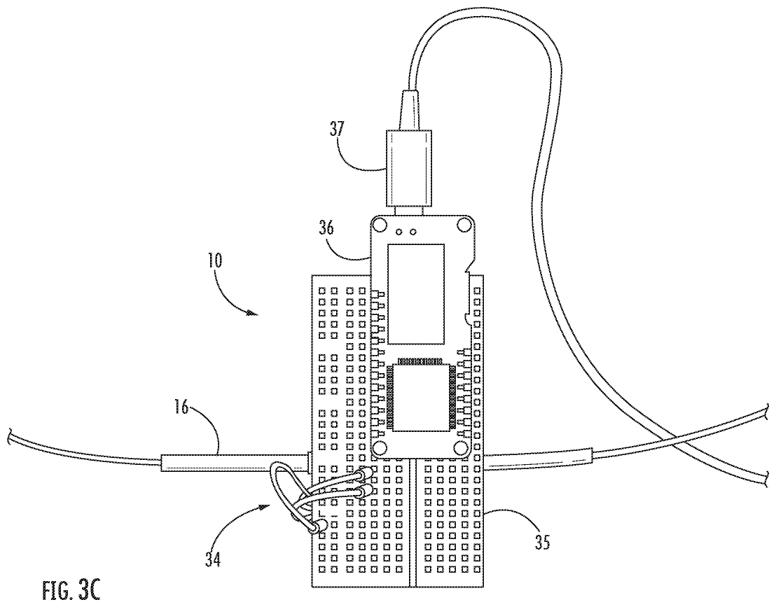

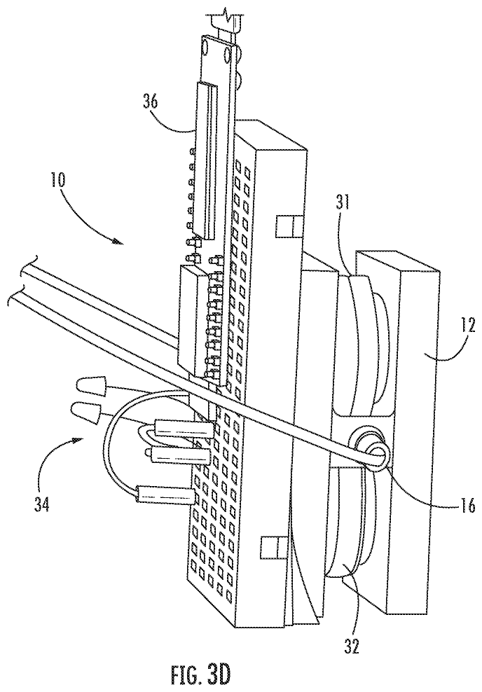

FIGS. 3A-3B depict counter 12 (also referred to as a tracking and quantification module) in greater detail. As shown in FIGS. 3A-3B, As discussed above, counter 12 serves as a dynamic metering device to track the dispensing of filament from reel 18. As shown in FIG. 3A, counter 12 includes two counter-rotating wheels mounted on independent ball-bearing axles—wheel 31 and wheel 32. The independent ball-bearing axles are shown in more detail in FIG. 3B, with bearing 36 being in mechanical communication with wheel 31 and bearing 37 being in mechanical communication with wheel 32. The ball-bearing axles are parallel, and wheels 31 and 32 are coplanar. Each of wheels 31 and 32 include an outer edge (or a circumferential surface) that at least partially intersects with a linear translation path of filament 16; however, as shown in particular in FIG. 3A, a separation gap exists between the circumferential surfaces of the respective wheels 31, 32, such that the wheels are not in direct communication with each other. The separation gap is sufficient to accommodate a diameter of filament 16 therethrough, such that filament 16 contacts both wheel 31 and wheel 32 when passing through device 10. Wheels 31 and 32 have surfaces designed with sufficient friction such that the tangential motion of filament 16 (or another body in contact with wheels 31 and 32) causes wheels 31, 32 to rotate. As such, since filament 16 contacts both wheel 31 and 32, and since wheels 31, 32 are capable of both clockwise and counterclockwise rotation, counter 12 accommodates bidirectional movement and bidirectional quantification of filament 16.

FIGS. 3C-3D depict an embodiment of modular filament feeding, tracking, and treating device 10 including counter 12. At least one of wheels 31, 32 is in electrical communication with a sensor that is capable of sensing and indicating movement indexes and directionality of bodies detected by the sensor, Device 10 includes breadboard 35 (or other microcontroller), with counter 12 being electrically coupled to breadboard 35 via electrical components 34. The index pulses detected by the sensor are translated by breadboard 35 into linear distance and direction, thereby indicating the relative movement of filament 16 with respect to counter 12 and device 10 as detected by the sensor in communication with at least one of wheels 31, 32. The results of the movement of filament 16 through counter 12 and device 10, and the data detected by the sensors coupled to device 10, are rendered in a readable format on computing device 36, which includes a screen and representations of the quantity of filament 16, as well as the direction of the movement of filament 16 and the rate at which filament 16 is used. Computing device 36 may be powered by a battery, or may be powered through an external source via power cable 37. In an embodiment, computing device 36 may be a processor or a memory that is in wired or wireless communication with an external computing device including a screen, such that the results of the quantification of filament 16 are interactable on an external computing device disposed at a location that is remote from device 10.

In an embodiment, device 10 includes optical and keypress inputs to associate individual reels 18 with strands of filament 16, such that each reel 18 includes a uniquely-encoded inventory identifier label. Non-exhaustive examples of labels are alphanumeric SIN labels, REED tags, bar codes, and QR codes, As such, as individual strands of filament 16 pass through device 10, sensors within device 10 not only detect the amount of filament 16 being used, but also the particular filament 16 that is used at a given moment. Breadboard 35 thereby displays the reel 18 identifier on computing device 36, in addition to the quantification information discussed above, informing the user about usage data for individual reels 18 of filament 16,

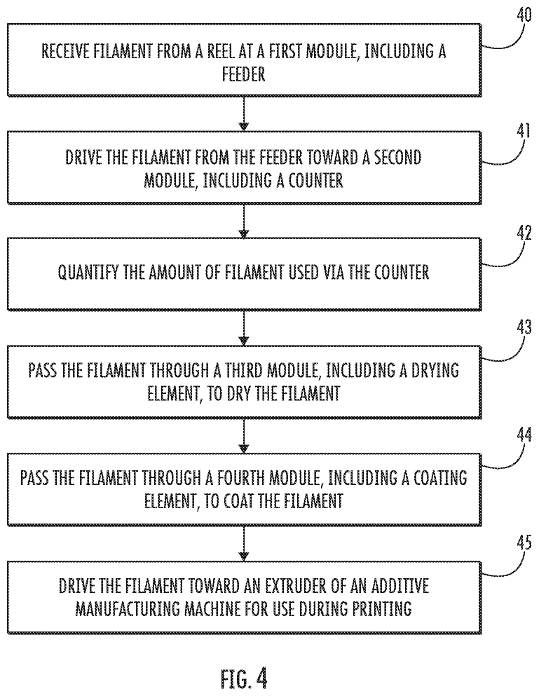

Turning now to FIG. 4, in conjunction with FIGS. 1-3D, an exemplary process-flow diagram is provided, depicting a method of treating filament for use in combination with an additive manufacturing printer. The steps delineated in the exemplary process-flow diagram of FIG. 4 are merely exemplary of a preferred order of securing a storage case to a vehicle, and the steps may be carried out in another order, with or without additional steps included therein.

The method begins at step 40, which includes receiving filament 16 at feeder 11 of device 10 from reel 18. Feeder 11 is considered a first module of device 10, and feeder 11 drives filament 16 throughout the remaining modules toward extruder 20 disposed on an additive manufacturing machine, such that filament 16 can be used during an additive manufacturing printing project. Next, during step 41, feeder 11 drives filament 16 toward counter 12, which is considered a second module of device 10. During step 42, counter 12 quantifies the amount of filament 16 passing therethrough, such as via a rotary system as described above, or a sensor-detection system. Importantly, bidirectional movement may be captured by counter 12, such that device 10 provides an accurate quantification of used and unused filament 16 by taking into consideration not only filament 16 translating toward extruder 20 for use, but also subtracting from a total amount any filament 16 translating back toward reel 18 that is unused in a printing process. During step 43, filament 16 passes through dryer 13, which is considered a third module of device 10. In an embodiment, feeder 11 continues to drive filament 16 through device 10 and toward extruder 20. During step 43, dryer 13 dries filament 16, such as by exposing filament 16 to a heating element, circulating air over filament 16, or other known drying methods, in an effort to remove a substantial amount of liquid from filament 16. During step 44, filament 16 passes through coater 14, which is considered a fourth module of device 10. Coater 14 coats filament 16, such as via paint, ink, or other fluids or sensing materials, which may be stored in a reservoir, as described in greater detail above. Finally, during step 45, feeder 11 drives filament 16 to extruder 20, which translates filament 16 to an additive manufacturing printer for use during a printing project.

### Glossary of Claim Terms

Counter: is a module of a device including a sensor that detects the presence of an object passing therethrough and provides an accurate quantification of the amount of the object passing through the device.

Feeder: is a motorized component that receives an object on a first end and drives the object toward a second end.

Filament: is a base material used in additive manufacturing printing, alternatively referred to as a feedstock, typically formed of thermoplastic or other polymer material.

Module: is a component of a combination device that performs a certain function, such as a counter or a feeder.

Reel: is a revolvable device that stores a material wound thereabout, such a filament used during additive manufacturing printing.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A modular device adapted to mechanically couple to an additive manufacturing printer, the additive manufacturing printer including an extruder, the modular device comprising:
a first module including a motorized feeder adapted to mechanically couple to a reel of filament, the feeder adapted to receive filament from the reel, and drive the filament through the device toward the extruder; and
a second module including a counter mechanically coupled to the feeder, the counter including a channel therethrough adapted to receive the filament therein, and including sensor adapted to bidirectionally detect the presence of the filament within the channel as the filament linearly translates through the second module toward the extruder.

2. The modular device of claim 1, further comprising a third module including a drying element disposed between the feeder and the extruder, the drying element adapted to receive filament from the feeder, dry the filament, and prepare the filament for printing as the filament linearly translates through the third module toward the extruder.

3. The modular device of claim 1, further comprising a fourth module including a coating element disposed between the feeder and the extruder, the coating element adapted to receive filament from the feeder and apply a coating on the filament as the filament linearly translates through the fourth module toward the extruder.

4. The modular device of claim 3, further comprising a reservoir disposed within the coating element, the reservoir containing the coating adapted to be applied to the filament.

5. The modular device of claim 1, wherein the second module further comprises a first end opposite a second end with the channel spanning from the first end to the second end.

6. The modular device of claim 5, wherein the second module further comprises a rotary assembly disposed between the first end and the second end, the rotary assembly including a wheel including a circumferential edge at least partially extending into the channel,
wherein the wheel is adapted to contact at least an amount of the filament, such that the wheel rotates upon a linear translation of the filament between the first and second ends.

7. The modular device of claim 6, wherein the wheel of the rotary assembly is a first wheel, further comprising a second wheel coplanar with the first wheel and disposed on an opposing side of the channel, the second wheel including a circumferential edge at least partially extending into the channel.

8. The modular device of claim 7, further comprising a gap defined by a lateral distance between the circumferential edge of the first wheel and the second wheel, the gap being smaller than a height of the channel.

9. The modular device of claim 8, wherein each of the first and second wheels of the rotary assembly is mechanically coupled to a bearing about a central axis of each wheel, reducing a frictional force acting on each wheel during rotation about the central axis.

10. A modular device adapted to mechanically couple to an additive manufacturing printer, the modular device comprising:
a quantification and tracking module including a first end opposite a second end with a channel spanning from the first end to the second end, the channel adapted to receive a strand of filament therethrough; and
a rotary assembly disposed between the first end and the second end, the rotary assembly including a first wheel coplanar with a second wheel, each of the first and second wheels including a circumferential edge at least partially extending into the channel,
wherein each of the first and second wheels are adapted to contact at least an amount of the strand of filament, such that each of the first and second wheels rotates upon a linear translation of the strand of filament between the first and second ends.

11. The modular device of claim 10, further comprising a gap defined by a lateral distance between the circumferential edge of the first wheel and the second wheel, the gap being smaller than a height of the channel.

12. The modular device of claim 10, wherein each of the wheels of the rotary assembly rotates in a clockwise direction and in a counterclockwise direction, such that the quantification and tracking module is adapted to track bidirectional linear translation of the strand of filament.

13. The modular device of claim 10, wherein each of the first and second wheels of the rotary assembly is mechanically coupled to a bearing about a central axis of each wheel, reducing a frictional force acting on each wheel during rotation about the central axis.

14. The modular device of claim 10, further comprising a motorized feeder in mechanical communication with the first end of the quantification and tracking module, the feeder adapted to mechanically couple to a reel including the strand of filament, the feeder adapted to receive the strand of filament from the reel, and drive the strand of filament through the quantification and tracking module toward an extruder of the additive manufacturing printer.

15. The modular device of claim 10, further comprising a drying element in mechanical communication with the second end of the quantification and tracking module, the drying element adapted to receive the amount of the strand of filament from the quantification and tracking module, dry the amount of the strand of filament, and prepare the amount of the strand of filament for printing as the amount of the strand of filament is driven toward an extruder of the additive manufacturing printer.

16. The modular device of claim 10, further comprising a coating element in mechanical communication with the second end of the quantification and tracking module, the coating element adapted to receive the amount of the strand of filament from the quantification and tracking module and apply a coating to the amount of the strand of filament as the amount of the strand of filament is driven toward an extruder of the additive manufacturing printer.

17. The modular device of claim 16, further comprising a reservoir disposed within the coating element, the reservoir containing the coating adapted to be applied to the amount of the strand of filament.

18. A method of preparing filament for use in combination with an additive manufacturing machine, the additive manufacturing machine including an extruder, the method comprising the steps of:
receiving, from a reel of filament, a portion of the filament at a first module, the first module including a motorized feeder;
driving the portion of filament from the feeder toward the extruder of the additive manufacturing machine;
passing the portion of filament through a second module, the second module including a counter mechanically coupled to the feeder, the counter adapted to bidirectionally detect the presence of filament as the filament linearly translates through the second module toward the extruder;
drying the portion of filament at a third module including a drying element; and
coating the portion of filament at a fourth module including a coating element.

19. The method of claim 18, wherein the second module further comprises a first end opposite a second end with a channel spanning from the first end to the second end, the channel adapted to receive the portion of the filament therethrough, and a rotary assembly disposed between the first end and the second end, the rotary assembly including a first wheel coplanar with a second wheel, each of the first and second wheels including a circumferential edge at least partially extending into the channel, the method further comprising the steps of:
passing the portion of filament through the channel of the second module;
contacting the portion of filament with the circumferential edge of each of the first and second wheels; and
rotating each of the first and second wheels as the filament linearly translates through the second module,
wherein an amount of rotation of each of the first and second wheels quantifies an amount of filament remaining on the reel.
